(19) United States
(12) Patent Application Publication
(10) Pub. No.: US 2010/0027796 A1
(43) Pub. Date: Feb. 4, 2010

(54) MULTI-ENCRYPTION

(75) Inventor: Arnaud Robert, Burbank, CA (US)

Correspondence Address: DISNEY ENTERPRISES, INC;C/O BERKELEY LAW & TECHNOLOGY GROUP, LLP, 17933 NW Evergreen Parkway, Suite 250, BEAVERTON, OR, 97006, US

(73) Assignee: Disney Enterprises, Inc., Burbank, CA (US)

(21) Appl. No.: 12/184,970

(22) Filed: Aug. 1, 2008

(51) Int. Cl. H04L 9/00

(52) U.S. Cl. 380/255

(57) ABSTRACT

Embodiments of methods, apparatuses, or systems associated with multi-encryption are disclosed.

### BACKGROUND

1. Field

The subject matter disclosed herein relates to encryption.

2. Information

Encryption schemes for encrypting data have continually evolved over the years and seem to be employed in an increasing number of contexts. Presently, for example, encryption schemes may be employed to encrypt data in communications, online data transfers, or multimedia content protection, to name only a few examples. The seeming ubiquity of encryption in the transmission of data, however, appears to have led to an increase in the temerity and ingenuity of hackers attempting to intercept or decrypt the encrypted data.

In recent years, for example, several encryption schemes have come under attack from cleaver hackers or the application of brute force computing power. Many attribute a hacker's ability to break an encryption scheme—or, stated differently, the weakness associated with various schemes of encryption—to the ever greater sophistication and processing capabilities of computer platforms today. Thus, to better ensure the secrecy of data, other encryption schemes for encrypting data may be desirable.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram depicting an embodiment of a method to encrypt one or more message portions;

FIG. 2 is a schematic diagram depicting an embodiment of a structure of an encrypted single message;

FIG. 3 is a schematic diagram depicting an embodiment of a method to decrypt one or more encrypted message portions; and

FIG. 4 is a schematic diagram depicting a networked embodiment of a system for encrypting, or decrypting, one or more encrypted message portions.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and,” “and/or,” and “or” as used herein may include a variety of meanings that will depend at least in part upon the context in which it is used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions or representations are the techniques used by those of ordinary skill in the data processing arts to convey the substance of their work to others skilled in the art. An algorithm is here, and generally, considered to be a self-consistent sequence of operations and/or similar processing leading to a desired result. The operations or processing involve physical manipulations of physical quantities. Typically, although not necessarily, these quantities may take the form of electrical or magnetic signals capable of being stored, transferred, combined, compared or otherwise manipulated. It has proven convenient, at times, principally for reasons of common usage, to refer to these signals as bits, data, values, elements, symbols, characters, terms, numbers, numerals or the like. It should be understood, however, that all of these and similar terms are to be associated with the appropriate physical quantities and are merely convenient labels. Unless specifically stated otherwise terms such as “processing”, “computing”, “calculating”, “determining” or the like refer to the actions or processes of a computing platform, such as a computer or a similar electronic computing device, that may be capable of performing mathematical or logical operations on data, which may also include being capable of storing the results of performing such operations. Thus, data, of course, may include, for example, any information which may be capable of being perceived, employed, stored, or transmitted by a computing platform, such as program code, executable instructions, or text, as non-limiting examples.

An often cited cryptographic maxim, known as Kerckhoff's principle, stipulates that the strength of an encryption scheme should lie in the secrecy of the encryption key, not in the secrecy of the encryption scheme itself. Accordingly, many encryption systems that adhere to Kerckhoff's principle tend generally to use an encryption scheme that is not secret. For instance, some systems, for example, may utilize well-known encryption schemes like DES or AES. Many abiding by Kerckhoff's principle seem to believe that, but for interception of the key, data encrypted with well-known encryption schemes could remain secret, even if the encrypted data was intercepted by a hacker.

To illustrate, a typical system for encrypting data utilizes a single encryption scheme like DES or AES, for example, to encrypt a single message. In this context, the term “single message” refers to a single collection of data where the data in the collection has a mutual relationship such that the message is capable of being perceived, employed or otherwise communicated, either directly or with the aid of a machine or device, by that collection of data. To illustrate, some examples of a message may include an audio, video or text file or stream, or computer-readable code, such as source code, as just a few examples.

A communication system that employs an encryption system typically sends the encrypted message to one or more recipients along a communication path, such as through a network, for example. In another instance, a computing platform, or the like, may store the encrypted message in a storage medium, such as a hard drive or a DVD, for example. Often, an initial encryption key, which may be referred to as a key seed, may be transmitted to one or more recipients along a communication path different than the one employed to transmit the encrypted message. Thus, even if the encrypted message is intercepted by a hacker, the message may be difficult to decipher without having also intercepted the key seed.

Depending, at least in part, on the encryption scheme utilized, some computing platforms may, for example, have the ability to decrypt a message within hours or days without utilizing the corresponding key seed. Therefore, tenacious hackers and accelerating computing power may tend to call into question the continued acceptance of the above approach as a way to maintain message secrecy.

The ability, and in some cases, the speed at which hackers may decrypt an encrypted message may impact certain transactions more so than others. For example, some businesses, such as those that rely on DVD sales, for example, tend to generate the majority of the revenue from the sale of a DVD within the first few weeks of its release. Thus, the ability of a computing platform to decrypt one or more messages stored on a DVD within hours or days from the release of the DVD may impact revenue generated from such sales. While the DVD example is merely illustrative of one context where stronger encryption and key management schemes may be desirable, the example may be readily extrapolated into nearly any context where maintaining the secrecy of a message may be desired. Thus, as mentioned previously, to better ensure the secrecy of a message, increasingly more robust encryption schemes for encrypting a message remain desirable.

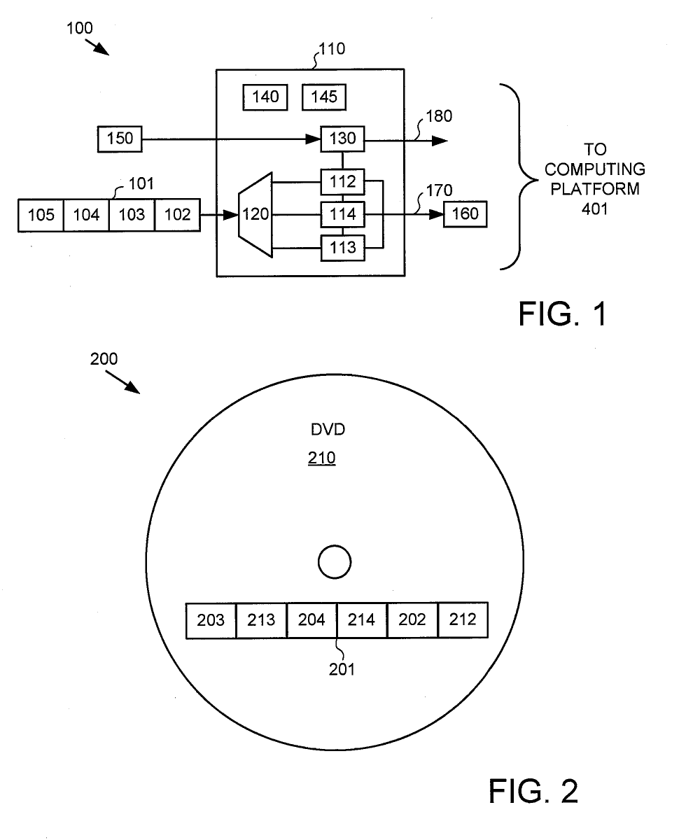

FIG. 1 is a schematic diagram depicting an embodiment 100 of a method to encrypt one or more message portions. Message portions 102, 103, 104 and 105 are shown as being different portions of single message 101. In this context the term “single message” refers to a single collection of data where the data in the collection has a mutual relationship such that the message is capable of being perceived, employed or otherwise communicated, either directly or with the aid of a machine or device, by that collection of data. Accordingly, then, in this context the term “portion”, or “message portion”, refers to some part of the data in the single collection of data comprising a single message. A single message may include any number of portions. Likewise, message portions may be fixed or of variable length. To illustrate, for example, portions 102 and 105 in FIG. 1 may not be the same length.

Embodiment 100 depicts an encryption process 110 receiving a single message 101, which in this embodiment, is partitioned into message portions 102-105. In some embodiments, encryption process 110 may employ a partitioning process, here depicted as partitioning process 120, to partition single message 101. For example, partitioning process 120 may partition single message 101 by employing defined function 140. To illustrate, as just one example, message portions may be formed by partitioning a single message into a number of bit groupings, where the length in bits of such groupings may vary based, at least in part, on a known or defined function, for example. Likewise, in some embodiments not depicted herein, a single message, such as single message 101, may be pseudo-randomly partitioned. In that instance, for example, a pseudo-random function may be applied. Thus, as merely an illustration, a pseudo-random process may generate a numeral to specify the number of bits for the length in bits of one or more message portions, such as specifying the lengths of message portions 102-105.

In other embodiments, a single message may be partitioned based, at least in part, on segmentation or structure present in message itself. For example, if a message comprises an MPEG format message, a partitioning process may partition a message based, at least in part, on frames present in the message itself, such as I-frames. Similarly, the partitioning process may alternatively or additionally partition or combine message portions of a single message. For example, a message may be received already partitioned into a plurality of message portions, such as message 101 is partitioned into message portions 102-105 in embodiment 100. Thus, as an example, partitioning process 120 may combine message portions 102 and 103 in embodiment 100 to form a single message portion. Varieties of techniques are known or may be developed to accomplish such partitioning and claimed subject matter is not limited to a particular technique.

Embodiment 100 depicts encryption process 110 applying a plurality of different encryption schemes 112-114. In this embodiment, encryption schemes 112-114 may comprise DES or AES, as just two examples. Here, process 110 receives message portions 102-105 and determines which encryption scheme, depicted as schemes 112, 113, or 114, are to be used to encrypt message portions 102, 103, 104 or 105. As with partitioning, a variety of ways exist for process 110 to determine which particular encryption scheme is to be utilized to encrypt a particular message portion.

Here, in embodiment 100, process 110 determines which encryption scheme 112-114 to apply to message portions 102-105 based, at least in part, on defined function 145. Thus, in embodiment 100, encryption scheme 112 is determined to encrypt message portion 102. Similarly, process 110 determines, based, at least in part on defined function 140, that message portion 103 is to be encrypted utilizing encryption scheme 113, message portion 104 is to be encrypted utilizing encryption scheme 114, and message portion 105 is to be encrypted utilizing encryption scheme 114.

It is important here to note that a variety of embodiments exist in which process 110 may determine which encryption scheme, such as schemes 112-114, may be utilized to encrypt one or more message portions, such as portions 102-105. These various embodiments may depend, at least in part, for example, on any one of a number of possible defined functions, such as a pseudo-random process. Process 110 may employ such a function to determine which encryption scheme to apply to one or more message portions, again, as an example.

As suggested, process 110 may use a pseudo-random function that associates message portions 102 and 104 with encryption scheme 114, and encrypt message portion 103 with encryption scheme 113. However, as another pseudo-random example, message portion 103 may be encrypted with encryption schemes 112, 113, and 114. In yet another example, the same function utilized for partitioning, such as function 140, may also determine which encryption scheme to apply.

In another embodiment, process 110 may group message portions to be encrypted, where the grouping may be based, at least in part, on a defined function, such as a pseudorandom process, for example. To illustrate, process 110 may use a function utilizing powers of two to group message portions. Using this function, for example, process 110 may encrypt a first two message portions, which may be encrypted with a particular encryption scheme, a next four message portions, which may be encrypted with another encryption scheme, followed by a next eight message portions, which may be encrypted with yet another encryption scheme, as a non-limiting example. In yet another example, process 110 may group some or all message portions of a particular single message as just described, but the size of the grouping may be determined pseudo-randomly.

In yet another embodiment, process 110 may dynamically switch between processes that determine, at least in part, which encryption schemes to utilize to encrypt one or more message portions, such as switching between defined functions, for example. For example, process 110 may use a defined function that associates encryption schemes 112 and 114 with message portions 102 and 105. Then, process 100 may switch to another defined function, which may then associate encryption scheme 113 with message portions 103, 104 and 105, for example. Process switching may occur, of course, anywhere. Thus, process or function switching may be applied to previously described aspects of encryption including partitioning a single message, grouping message portions, or associating encryption schemes with message portions or groupings of message portions, as some examples.

Process 110 may also generate or select key material 130. In this embodiment, key material may comprise an encryption key or a key seed, as non-limiting examples. Key material in this embodiment may also comprise an encryption tag, which will be discussed in more detail below. A variety of ways in which process 110 may generate or select key material are possible. For example, in this embodiment, encryption process 110 may generate key material 130 based, at least in part, on key seed 150. Thus, for example, key seed 150 may comprise a value, which if input or supplied to process 110, such as is depicted in embodiment 100, may be used by process 110 to generate key material 130.

In some embodiments, the key material, such as key seed 150, may be generated by process 110. For example, process 110 may generate key material based, at least in part, on a defined function. To illustrate, process 110 may generate key material wherein the length of a particular message portion may be selected to determine the key seed or encryption key, for example. In yet another embodiment, a key seed, or an encryption key, may be generated independently of process 110. As an example illustration, key material, such as key seed 150, or an encryption key, such as encryption key 130, may exist within an unencrypted single message, such as within message 101. Thus, process 110 may select and utilize an existent key material.

In embodiment 100, key material 130 may comprise an encryption key for encryption schemes 112-114. In other words, key material 130 in this embodiment comprises an encryption key, which is common to encryption schemes 112, 113 and 114. In alternative embodiments (not shown), however, process 110 may generate or select key material, such as generating or selecting a plurality of encryption keys or key seeds, which may relate to a plurality of encryption schemes. Thus, for example, in an embodiment, particular key material, such as key material 130, may be only relevant to a particular encryption scheme, such as scheme 112.

As another example, regarding key material, process 110 may generate or select a first key material, such as key material 130, with subsequent key material being generated or selected, at least in part, based on a first key material, or based a one or more previous key materials. In yet another example, process 110 may generate or select key material based, at least in part, on a defined function, which may be based, at least in part, on elapsed time. Thus, for example, after a first key material, such as key material 130, is generated, process 110 may generate subsequent key material after a particular amount of time.

Embodiment 100 depicts an encrypted single message 160 being transmitted along communication path 170. Of course, path 170 may comprise a wireless communication path to computing platform 401 in FIG. 4, for example. Also, in another embodiment, however, one or more message portions, such as message portions 102-105, may be transmitted separately. In still another embodiment, an encrypted single message, such as message 160, or one or more encrypted message portions, may be stored on a storage medium, such as on hard drive on computing platform 401 in FIG. 4, or on a DVD, such as DVD 210 in FIG. 2, as non-limiting examples. In embodiment 100, encrypted single message 160 is intended to be received by at least one recipient, such as by computing platform 401 in FIG. 4.

Embodiment 100 also shows key material 130 being transmitted along communication path 180, such as being transmitted wirelessly to computing platform 401 in FIG. 4, as previously suggested. In this particular embodiment, key material 130 is transmitted along communication path 180, which is different than the communication path employed to transmit encrypted single message 160, that is, path 170, as discussed above in this example. Of course, communication path 170 may differ from communication path 180 in a variety of respects other than being physically separate. Paths 170 and 180 may be logically distinct, or utilize different communication protocols, as just a few examples.

Of course, claimed subject matter is not limited to any one particular transmission approach. For example, in some embodiments, key material may not be transmitted. Alternatively, in some embodiments, less than all key material is transmitted. Furthermore, key material may be respectively transmitted via one or more separate or different communication paths, such as paths 170 and 180, similar to the approach of using different paths for a message and a key.

Of course, key material, such as key material 130, need not be transmitted if a recipient process is in possession of the function or process employed to select or generate particular key material. Said another way, the recipient process may already store, or have access to, the information utilized by process 110, such as defined function 140 in embodiment 100, to determine which portions are to be encrypted with particular encryption schemes. A recipient process may therefore decrypt one or more received encrypted message portions through access to this information. In a more complex approach, for example, process 110 may transmit a key seed, such as key seed 150, or an encryption key, and one or more functions to generate subsequent key material. Thus, receipt of a key seed or encryption key with one or more functions may inform a recipient process how to generate subsequent key material. Additional permutations of the previous description are also intended to be within the scope of claimed subject matter.

In some embodiments, key material, such as key material 130, may be transmitted with one or more message portions, or with the encrypted message, such as message 160. Thus, a different communication path to transmit one or more keys may be omitted. Likewise, key material or functions may be encrypted. Encryption may be in accordance with available encryption techniques, such as PKI or asymmetrical encryption, known to a recipient process. Of course, those skilled in the art will appreciate that all the above examples or illustrations are mere illustrative of claimed subject matter; accordingly, they do not limit the scope of claimed subject matter.

Embodiment 100 includes a variety of advantages. One advantage of embodiment 100, for example, may be that an encrypted message 160 may be more difficult to decrypt relative to conventional encryption techniques. For example, to decrypt encrypted message 160, a hacker might tend to focus on a portion of the code that he or she believes may be relevant to decryption. In embodiment 100, however, message portions exist such that even if a hacker figured out how to decrypt that particular portion, he or she still may not be able to decrypt other portions. This may occur, for example, since other portions may be encrypted with different encryption schemes in an embodiment. Likewise, a hacker may have difficulty determining where a message portion begins or ends, particularly if message portions vary in size, for example. Yet another advantage may be that some conventional devices or software applications may be able to implement embodiment 100, or numerous other embodiments, without the need to make significant modifications.

Embodiments that involve dynamic process switching, such as switching between defined functions, for example, may tend to add complexity to an encrypted message, such as message 160, such that it may make decryption for a hacker more difficult. Likewise, key material, such as key seeds or encryption keys, or functions may be more difficult to intercept or identify, depending, at least in part, on the particular embodiment, which may therefore make decrypting the encrypted message, such as message 160, more difficult. Other variations or embodiments may, of course, have additional advantages.

FIG. 2 is a diagram depicting embodiment 200 of a structure of an encrypted single message 201 stored on DVD 210. Alternatively, encrypted single message 201 may be transmitted or stored in another type of storage device, such as a memory device, magnetic storage device, or optical storage device, as non-limiting examples. Likewise, encrypted single message 201 is only one possible embodiment of the structure of encrypted single message 160 in FIG. 1.

Referring again to FIG. 2, single message 201 shows a scheme which alternates between encrypted content and other information, wherein the other information in this embodiment comprises encryption tags. In this context, the term encryption tag refers to information or data, associated with one or more encrypted message portions, that may be useful for decrypting the one or more encrypted message portions. Examples of an encryption tag, without limitation, of course, may include key material, a defined function, such as of the type previously described, or other meta-type data. Embodiment 201 depicts encryption tags 212, 213 and 214 interspersed with encrypted message portions 202, 203 and 204. In this embodiment, encryption tags 212, 213 and 214 are shown adjacent to encrypted message portions 202, 203, and 204, respectively. Also, in this embodiment, encryption tags 212-214 may have been generated by an encryption process, such as process 110 in FIG. 1.

Although, as shown, encryption tags may be interspersed with encrypted message portions, in some embodiments, tags need not be generated, or fewer or more tags may be generated relative to the number of message portions. However, in encrypted message 201, the number of message portions and encryption tags are the same. Encryption tags 212-214, of course, may employ various sizes or may be interspersed in such a way as to bear no relation the message portions or other tags. Thus, for example, tag 214 may contain information relevant to message portion 203, or tag 214 may contain more data than another tag. As another example, tag 213 may be the only tag in encrypted message 201.

As alluded to previously, tags 212-214 may contain information useful for identifying applied encryption schemes, such as encryption schemes 112-114 in FIG. 1. Similarly, tags 212-214 may contain information useful for identifying or generating key material, such as key material 130 in FIG. 1, for example, or for identifying process switching, as previously described. In addition, tags 212-214 may also contain information useful for identifying or conveying information relevant to partitioning an encryption message. Also, in some embodiments, one or more tags may be encrypted. Thus, for example, similar to the previous discussion with respect to process 110 in FIG. 1 encrypting key material, one or more tags may be encrypted using an available standard encryption technique, such as PKI or asymmetrical encryption, which may be known by, or available to, a recipient process. Of course, alternatively, a propriety technique may be employed or a standard technique may be modified. Also, in some cases, a recipient process may already store or have access to information useful for decrypting an encrypted single message, so that encryption tags may be omitted.

Embodiment 200 depicts encryption tags 212-214 as being stored with encrypted single message 201 on DVD 210. In alternative embodiments, however, encryption tags, such as tags 212-214 may be stored apart from encrypted single message 201. Likewise, encryption tags may be transmitted on one or more communication paths other than the communication path employed to transmit an encrypted single message. For example, encryption tags 212-214 may be transmitted along communication path 180 in FIG. 1.

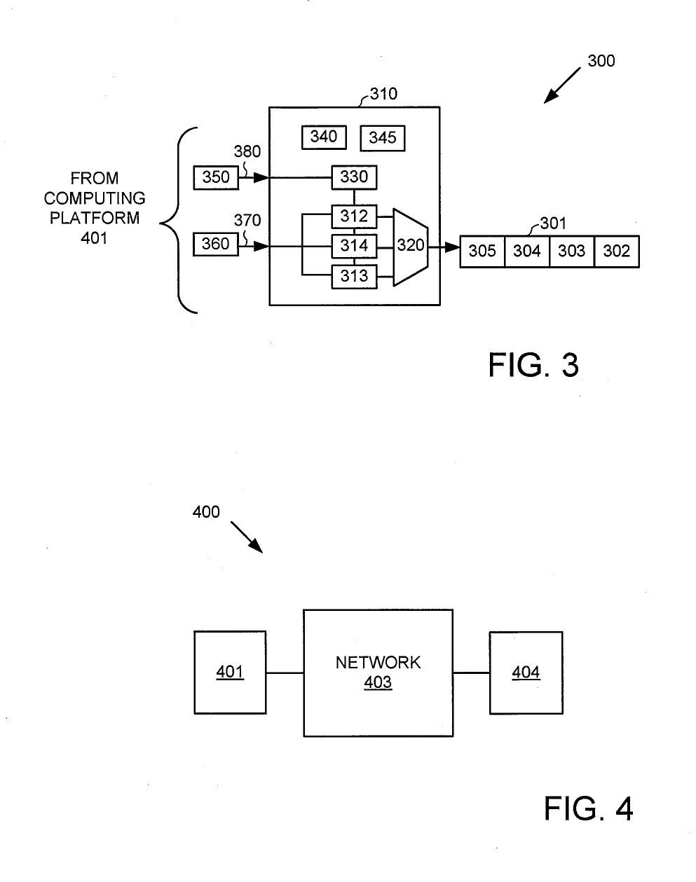

FIG. 3 is a schematic diagram depicting an embodiment of a method to decrypt an encrypted message, such as encrypted message 360. Embodiment 300, for example, depicts decryption process 310 receiving encrypted single message 360. Of course, while embodiment 300 depicts process 310 receiving encrypted single message 360, in other embodiments, process 310 may access a storage medium, such as DVD 210 shown in FIG. 2, with encrypted single message 360, or one or more message portions, stored thereon.

Embodiment 300 depicts process 310 receiving key material 350. In this embodiment, key material 350 is shown being transmitted along or via communication path 380, whereas communication path 370 is used to transmit encrypted single message 360. A variety of permutations are possible for a decryption process 310 to receive key material, similar to permutations of the encryption process. This may include, for example, one or more encryption keys, key seeds, or tags being received with an encrypted single message, one or more encryption keys, key seeds, or tags being received via a plurality of communication paths, or no encryption keys, key seeds, or tags being received.

As just an example, with respect to decryption, process 310 may utilize information included in one or more encryption tags, such as tags 212-214 in FIG. 2, to identify encryption schemes. Thus, one or more tags may, for example, convey the encryption schemes, the partitioning process, the size or order of message portions, the points at which to process switch, or other information, as non-limiting examples.

Process 310 in embodiment 300 is depicted as decrypting message portions 302-305. For example, as mentioned previously, process 310 in this embodiment receives encrypted single message 360 and also receives key material 350. Here, key material 350 comprises encryption tag 330, which additionally comprises an encryption key common to the encryption schemes utilized. Thus, in this embodiment, process 310 may be capable of identifying this aspect of the applied encryption scheme based on the information conveyed by encryption tag 330. Alternatively, as mentioned previously, process 310 may be fixed and tag 330 may comprise an encryption key only. However, in this embodiment, process 310 instead stores function 345, which is here utilized by process 310 to determine which encryption scheme to use to decrypt particular message portions of encrypted single message 360, as previously described. Thus, process 310 identifies encryption schemes 312-314 as having been utilized to encrypt message portions 302-305 of encrypted single message 360.

Process 320 is shown here recombining message portions to reproduce message 301. In this embodiment, process 320 reproduces message 301 by recombining message portions 302-305. Process 320 may use key material or other information, such as a function or pseudo-random process, such as previously described, to recombine message 301 from message portions 302-305, as an example. Thus, in this embodiment, process 320 utilizes function 340, at least part, which may have been received with key material 350, to recombine message portions 302-305. Alternatively, function 340 may by itself be used to recombine message portions 302-305, or process 320 may use properties of message portions, such as previously described, to recombine message portions 302-305.

FIG. 4 is a schematic diagram depicting a networked embodiment of a system in accordance with claimed subject matter. Embodiment 400 depicts computing platform 401. Here, 401 is capable of encrypting one or more single messages, such as encrypted single message 160 shown in FIG. 1. One or more single messages, for example, may be encrypted in any manner, in accordance with claimed subject matter, such as ones previously described. Likewise, platform 401 may transmit an encrypted single message to network 403. Platform 401 may also transmit key material, such as one or more encryption keys, key seeds or encryption tags, or one or more functions, at least in part, to one or more computing platforms, such as platform 404, or to network 403, for example.

Here, platforms 401 and 404 may comprise clients of network 403, which are shown communicatively coupled to network 403. In this embodiment, platform 404 is capable of decrypting one or more encrypted single messages, such as encrypted single message 360 in FIG. 3, for example. Thus, platform 404 may receive an encrypted single message from network 403. Likewise, platform 404 may receive information for the decryption process.

In another embodiment, computing platforms 401 or 404, along with other computing platforms in network 403, may be capable of performing encryption and transmittance, reception and decryption, or any combinations or subcombinations thereof. For example, platform 404 may encrypt and transmit an encrypted single message to network 403. Platform 404 may also transmit an encryption function to platform 401 via a different communication path. Network 403 may transmit an encrypted single message from platform 404 to platform 401. Platform 401, having received encryption function information from platform 404, may decrypt the encrypted single message received from network 403. Of course, those skilled in the art will appreciate that the above examples are merely illustrative of claimed subject matter, and, accordingly, do not limit the scope of claimed subject matter.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
encrypting a portion of a single message, said single message to have portions to be encrypted using different encryption schemes.

2. The method of claim 1, further comprising encrypting additional portions of said single message.

3. The method of claim 1, wherein said single message includes at least two portions; wherein said encrypting includes encrypting said at least two portions with different encryption schemes.

4. The method of claim 1, wherein the single message is received by at least one recipient.

5. The method of claim 3, wherein said different encryption schemes comprise encryption schemes selected based, at least in part, on a defined function.

6. The method of claim 5, wherein said defined function comprises a pseudo random process.

7. The method of claim 1, wherein said encrypting a portion of a single message includes partitioning said single message into a plurality of message portions.

8. The method of claim 7, wherein said partitioning results in at least some portions of varying length.

9. The method of claim 1, further comprising:
transmitting said encrypted portion of said single message along a communication path.

10. The method of claim 1, further comprising:
generating key material prior to said encrypting.

11. The method of claim 10, wherein said generating key material comprises generating one or more key seeds; one or more encryption keys; or one or more encryption tags.

12. The method of claim 10, wherein generating key material comprises:
generating a first key material; and
generating subsequent key material based at least in part on one or more prior key materials.

13. The method of claim 10, further comprising:
transmitting key material via a communication path.

14. The method of claim 13, wherein said key material is transmitted with one or more portions of said single message.

15. The method of claim 13, wherein said key material is transmitted via a communication path different from a communication path employed to transmit one or more portions of said single message.

16. A method comprising:
decrypting at least one portion of a single message, said single message having portions to be decrypted using different decryption schemes.

17. The method of claim 16, wherein said single message is received by at least one recipient.

18. The method of claim 16, further comprising:
receiving said at least one portion of said single message prior to said decryption.

19. The method of claim 16, further comprising:
receiving prior to said decryption key material used to encrypt said at least one portion of said single message.

20. A method comprising:
transmitting at least one portion of a single message, said single message having portions encrypted using different encryption schemes.

21. The method of claim 20, wherein said transmitting at least one portion of a single message includes transmitting key material.

22. A method comprising:
receiving at least one portion of a single message, said single message having portions to be decrypted using different decryption schemes.

23. The method of claim 22, wherein said receiving at least one portion of a single message includes receiving key material.

24. A system comprising:
a computing platform; said computing platform operable to encrypt different portions of a single message using different encryption schemes.

25. The system of claim 24, wherein said computing platform is further operable to transmit at least one portion of said single message.

26. The system of claim 24, wherein said computing platform is further operable to be communicatively coupled to a network.

27. A system comprising:
a computing platform; said computing platform operable to decrypt a portion of a single message; said single message having portions to be decrypted using different decryption schemes.

28. The system of claim 27, wherein said computing platform is further operable to receive at least one portion of said single message.

29. The system of claim 27, wherein said computing platform is further operable to be communicatively coupled to a network.

30. An article comprising: a storage medium having stored thereon encrypted data; wherein said encrypted data includes one or more single messages; wherein for a single message different portions of the encrypted data are capable of being decrypted using different decryption schemes.

31. The article of claim 30, wherein a single message comprises at least two message portions.

32. The article of claim 30, wherein at least one message portion of said at least two message portions includes key material.

33. The article of claim 30, wherein at least one message portion of said at least two message portions varies in length relative to another message portion.

34. A method, comprising:
encrypting a single message having more than one message portion such that different encryption schemes encrypt different message portions; and decrypting a single encrypted message such that different decryption schemes decrypt different encrypted message portions.

35. The method of claim 34, wherein said decrypting a single encrypted message comprises decrypting the encrypted single message having more than one message portion such that different encryption schemes encrypt different portions.
